(19) United States
(12) Patent Application Publication
(10) Pub. No.: US 2013/0090494 A1
(43) Pub. Date: Apr. 11, 2013

(54) TETRAKIS[BIS(DIHYDROXYPHOSPHORYL)METHYL]CALIX[4]ARENE OR ITS SODIUM SALT THEREOF AS FIBRIN POLYMERIZATION INHIBITORS

(71) Applicants: Serhii Vasyl'ovych Komisarenko, Kyiv (UA); Eduard Vitaliiovych Lugovs'Koi, Kyiv (UA); Pavlo Gryhorovych Grytsenko, Kyiv (UA); Vitalii Ivanovych Kal'Chenko, Kyiv (UA); Tetiana Anatoliivna Koshel', Kyiv (UA); Serhii Oleksiiovych Cherenok, Kyiv (UA); Oleksandr Anatoliiovych Yushchenko, Kyiv (UA); Evhenii Oleksandrovych Kolesnyk, Kryvyi rih (UA)

(72) Inventors: Serhii Vasyl'ovych Komisarenko, Kyiv (UA); Eduard Vitaliiovych Lugovs'Koi, Kyiv (UA); Pavlo Gryhorovych Grytsenko, Kyiv (UA); Vitalii Ivanovych Kal'Chenko, Kyiv (UA); Tetiana Anatoliivna Koshel', Kyiv (UA); Serhii Oleksiiovych Cherenok, Kyiv (UA); Oleksandr Anatoliiovych Yushchenko, Kyiv (UA); Evhenii Oleksandrovych Kolesnyk, Kryvyi rih (UA)

(21) Appl. No.: 13/640,557

(22) PCT Filed: Apr. 11, 2011
(86) PCT No.: PCT/UA2011/000026

§ 371 Date: Oct. 11, 2012

(30) Foreign Application Priority Data
Apr. 13, 2010 (UA) A 2010 04273

(51) Int. Cl. C07F 9/38

(52) U.S. Cl. 562/21

(57) ABSTRACT

There is proposed a chemical compound of 5,11,17,23-tetrakis[bis(dihydroxyphosphoryl)methyl]calix[4]arene and a sodium salt thereof, which can be used as antithrombotic agents. A highly specific inhibiting effect of the aforementioned calixarenes on the fibrin polymerization has been identified. It has been found that the addition of the aforementioned calixarenes to blood plasma leads to an increase of the prothrombin time and the activated partial thromboplastin time.

### CROSS-REFERENCES TO RELATED APPLICATIONS

This application is a U.S. national phase application of a PCT application PCT/UA2011/000026 filed on 11 Apr. 2011, published as WO/2011/129796, whose disclosure is incorporated herein in its entirety by reference, which PCT application claims priority of a Ukrainian patent application UA a201004273 filed on 13 Apr. 2010.

### FIELD OF THE INVENTION

The invention refers to the field of organic chemistry and biochemistry, namely to the synthesis of new chemical compounds:

5,11,17,23-tetrakis[bis(dihydroxyphosphoryl)methyl]calix[4]arene (calixarene C-192) and its sodium salt (calixarene C-145) with formulas:

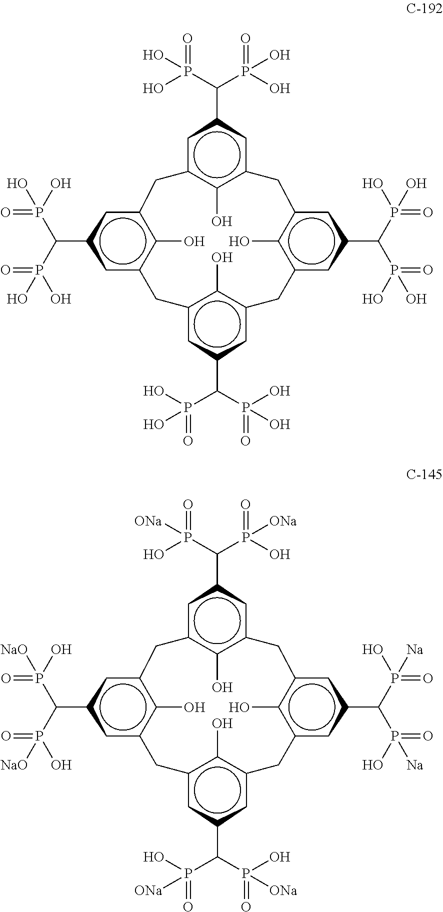

and used them as specific inhibitors of fibrin polymerization. Identified properties allow their use as a substance for antithrombotic drugs.

### BACKGROUND OF THE INVENTION

The synthesis and physic-chemical properties of the declared calixarene C-192 and its sodium salt (calixarene C-145) are not described in literature.

It is known that the purified natural peptide isolated from fibrinogen fragment D, which has the amino acid sequence Thr-Arg-Trp-Tyr-Ser-Met-Lys-Lys-Thr-Thr-Met-Lys-Ile-Ile-Pro-Phe-Asn-Arg-Leu-Thr-Ile-Gly-Glu-Gly-Gln-Gln-His-His-Leu-Gly-Gly-Ala-Lys-Gln-Ala-Gly-Asp-Val, is an inhibitor of fibrin polymerization [1].

However, the peptide cannot be used as the basis of an antithrombotic drug because of the high molecular weight and high cost.

It is known that fibrin polymerization inhibitor is a synthetic peptide Gly-Pro-Arg-Pro [2, 3]. However, he does not show enough of the inhibitory actions on fibrin polymerization.

It is known that the carboxamide compounds have inhibitory effect of fibrin polymerization in the blood plasma [4], but the no information is available about the value of their inhibitory activity.

5,17-bis[bis(dihydroxyphosphoryl)methyl]-25,27-dipropoxycalix[4] arene (calixarene C-98) is the closest analogue to the structure [5] and to the action [6] to a declared compounds with the following formulas:

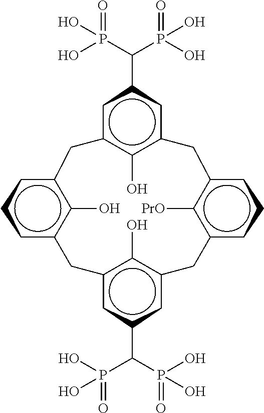

The inhibitory activity of calixarene C-98 on fibrin polymerization, identified by turbidity analysis showed that the value of the calixarene concentration at which the polymerization is inhibited by 50% (IC₅₀) is 1.3·10⁻⁴ M [6], which indicates a low affinity of the compound and calixarene C-98 cannot be considered as the basis for the substance of anti-thrombotic drugs.

The creation of small molecule non-peptide nature of a series of calixarenes, which would be an effective inhibitor of fibrin polymerization was the basis or of the declared invention.

### PREFERRED EMBODIMENTS OF THE INVENTION

This object is achieved by synthesis of calixarene C-192 and its sodium salt (C-145). Calixarene C-192 obtain by sequence reaction of tetraformylcalixarene (X) with of diisopropylphosphite in the presence of metallic sodium and subsequent dealkylation received 5,11,17,23-tetrakis[bis(diisopropoksiphosphoril)methyl]calix[4] arene (tetrabisphosphonata (Y)) by trimethylbromsilan and methanol. The declared sodium salt of calixarene C-192 (calixarene C-145), prepared by the reaction of calixarene C-192 with sodium methylate in a molar ratio of 1:8 in absolute methanol solution and evaporating the solution in a vacuum at 20° C.

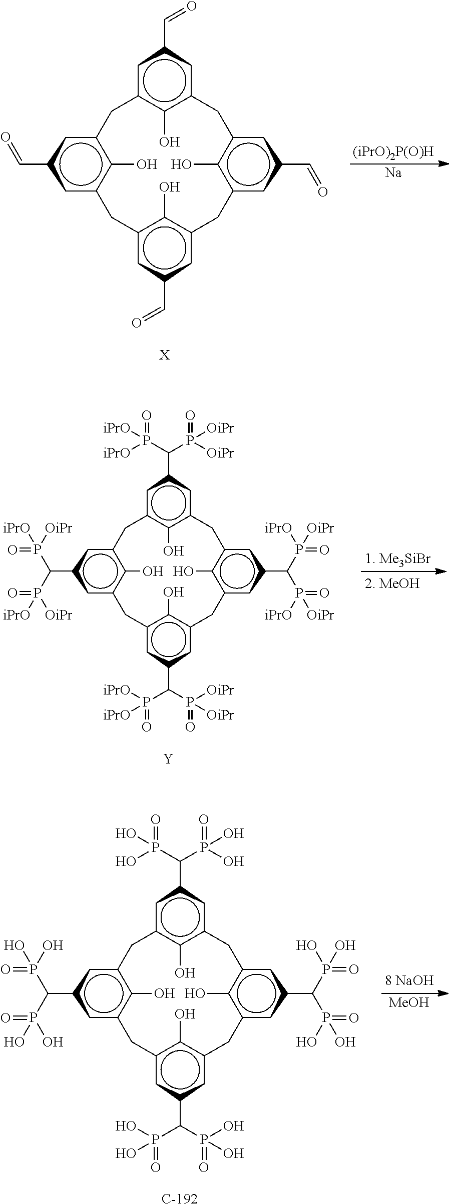

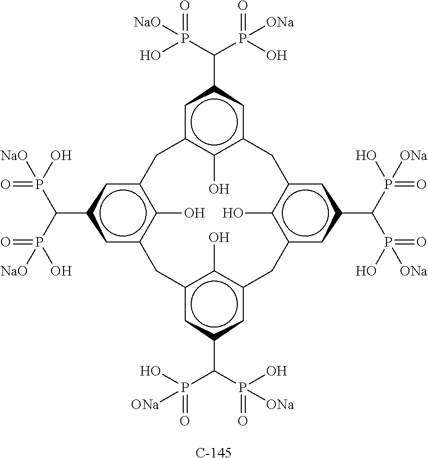

where: (iPrO)₂P(O)H—iisopropylphosphite;
iPr—isopropyl groups; Me₃SiBr—trimethylbromsilan; MeOH—methanol.

Turbidity analysis showed that the declared calixarene C-192 inhibits specifically the fibrin polymerization in the thrombin-fibrinogen reaction. The IC₅₀ value was 0.5·10⁻⁶ M. Thus, as an inhibitor of fibrin polymerization the calixarene C-192 is second-order efficient than its closest analogue calixarene C-98 [5, 6]. The measuring shows that the inhibition is achieved at a molar ratio of calixarene C-192 to fibrinogen 1.7:1.

The fibrin polymerization by the action of thrombin on fibrinogen consists of two reactions: 1) thrombin-catalyzed conversion of fibrinogen to fibrin and 2) polymerization of the fibrin monomer to form three-dimensional network, which is the framework of thrombus. The declared calixarene C-192 inhibits not only polymerization in the thrombin-fibrinogen reaction (IC₅₀=0.5·10⁻⁶ M), but also the fibrin monomer polymerization (IC₅₀=1.0·10⁻⁶ M). Thus, inhibitory effect of the declared calixarene C-192 realized by interaction with fibrin.

The results showed that the IC₅₀ value of the declared calixarene C-145 is 2.5·10⁻⁶ M. It indicates high inhibitory effect of fibrin polymerization. Furthermore, because of electro neutrality of the declared calixarene-145 molecule, it may be more suitable for injection to a living organism as an inhibitor of fibrin polymerization and the process of blood clotting, as well.

The presented data validity confirmed by the fact that in the control study we have experimentally obtained practically the same value of IC₅₀ (0.5·10⁻⁴ M) of synthetic peptide Gly-Pro-Arg-Pro, common known inhibitor of fibrin polymerization, as it was obtained by other authors (0.85·10⁻⁴ M) [2].

At present, it has not yet been described any low molecular weight compound with non-peptide nature, which has as high inhibitory activity on the process of fibrin polymerization, as declared calixarenes C-192 and C-145.

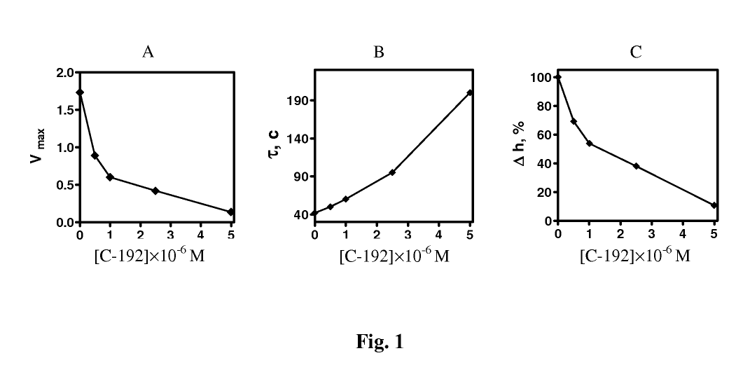

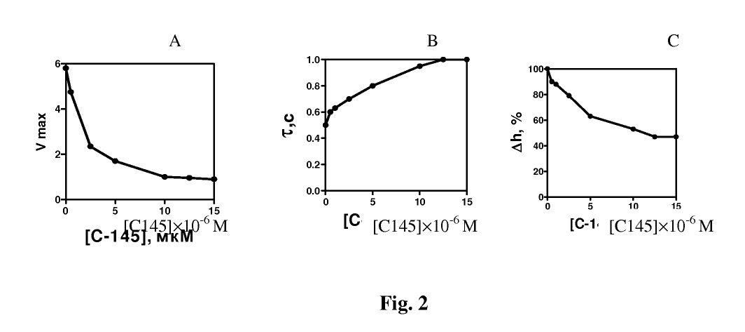

Obtained data indicates that the declared calixarenes C-192 and C-145 retards the fibrin polymerization in the thrombin-fibrinogen reaction not by inhibiting the active site of thrombin or its binding to fibrinogen, but by inhibiting the process of fibrin polymerization. In the presence of the declared calixarene C-192 in the fibrin polymerization medium (FIG. 1) significantly decreased the maximum rate of polymerization (Vmax), increases the lag-time (τ) and decreased the final turbidity of fibrin clot (FIG. 2).

In the presence of the declared calixarene C-145 (sodium Na-salt of the calixarene C-192) in the fibrin polymerization medium desAABB (FIG. 2) significantly decreased the maximum rate of fibrin polymerization (Vmax), the maximum turbidity of fibrin clot (Δh) and increases the lag-time (τ).

Transmission electron microscopy, performed by microscope H-600 (“Hitachi”, Japan) at 50000 magnification, indicates that the declared calixarene C-192 inhibits the first stage of fibrin polymerization protofibril formation from its monomeric molecules.

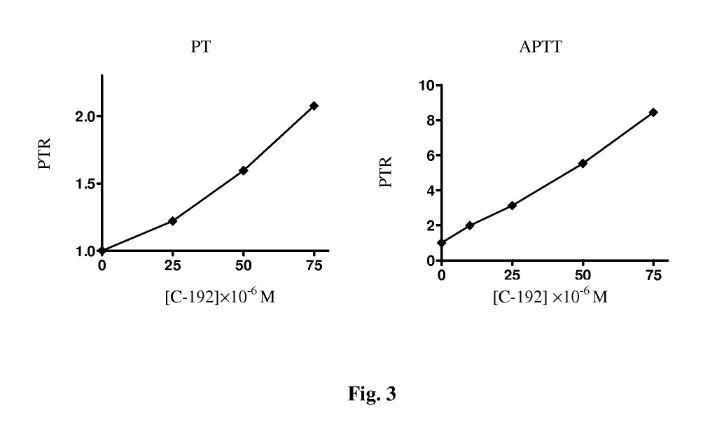

To ascertaining the capabilities of calixarenes usage as antithrombotic agents was investigated the inhibitory effect of the declared calixarene C-192 to the blood clotting. The addition of declared calixarene C-192 to the plasma (FIG. 3) increases as the prothrombin time (PT) and activated partial thromboplastin time (APTT). The calixarene C-192 doubles both the prothrombin time (PT) and APTT in normal human blood plasma at concentrations of 7.0·10⁻⁵ M and 1.7·10⁻⁵ M, respectively (FIG. 3) [6].

Thus, the presence of components of blood plasma does not affect to the inhibitory effect of the declared calixarene C-192 to fibrin polymerization. Therefore declared calixarenes C-192 and C-145 is recommended to use as a suspension for antithrombotic drugs.

The previous scientific experiments with healthy adult mice, using the method described by other authors [8], have shown that the declared calixarene C-192 is median toxic compound (LD₅₀ is 780 mg/kg, perorally).

The invention is illustrated by the following examples.

### Example 1

The obtaining of tetrabisphosphonate (Y).

Sodium metal (0.69 g, 29 mM) was dissolved in 15 ml solution of diisopropyl phosphate. Tetraformylcalixarene (1 g, 1.86 mM) was added to the resulting solution. The reaction mixture was stirred at 20° C. for 48 h and then quenched with water (100 mL) and thrice extracted with chloroform (50 ml). The chloroform layer was dried under vacuum at 0.05 mmHg or 10 h at 100° C. The formed an oil is washed with hexane. The obtained 3 g of tetrabisphosphonat (Y) as a light-brown crystals (yield 95%). Tm 65-67° C., ¹H NMR (300 MHz, CD₃OD): δ_{H}: 7.18 (C, 8H, PhOH); 4.85 (m, 8H, OCH); 4.38 (m, 8H, OCH); 3.95 (s, 8H, s, 8H, ArCH₂); 3.45 (t, 4H, J_{pH}=25 Hz, PCH); 1.35, 1.25, 1.18, 0.95 (d, 30H+30H+18H+18H); ³¹P NMR δ 19.5.

### Example 2

The obtaining of 5,11,17,23-tetrakis[bis](dihydroxyphosphoryl)methyl calix[4]arene (calixarene C-192).

The bromotrimethylsilane (5.46 g, 35 mM) was added to a solution (1 g, 0.55 mM) of tetrakis-bisphosphonate (Y) in dry chloroform (15 mL).

The reaction mixture was stirred at 20° C. for 30 h and then the solvent was evaporated and the residue was dissolved in absolute methanol (15 mL). The reaction mixture was stirred at 50° C. for 2 h, the methanol was evaporated under reduced pressure, the residue was dried under vacuum at 0.05 mmHg for 10 hours to give 0.59 g of calixarene C-192 as a light brown crystals (98% yield). Tm>200° C. (dec.). ¹H NMR (300 MHz, CD₃OD): 7.45 (s, 8H, PhOH); 4.25 (d, 4H, J_{HH}=13 Hz, ArCH₂); 3.65 (d, 4H, J_{HH}=13 Hz, ArCH₂); 3.55 (t, 4H, J_{pH}=25 Hz, PCH); ³¹P NMR δ 16.5.

### Example 3

The obtaining of octasodium salt of 5,11,17,23-tetrakis [bis](dihydroxyphosphoryl)methyl calix[4]arene (calixarene C-145).

The sodium melitat (77 mg, 1.428 mM) in absolute methanol (5 ml) was added to a 0.2 g (0.179 mmol) of calixarene C-192. The reaction mixture was stirred for 1 h at 20° C. The methanol was evaporated under vacuum at 20° C. The reaction yield is 230 mg of calixarene C-145 in the form of white crystals (yield 99.6%), Tm>100° C. (dec.), ³¹P NMR δ 14.5.

### Example 4

The turbidity analysis of desAABB fibrin polymerization and of fibrin polymerization in the fibrinogen+thrombin reaction in the present and the absent of declared calixarenes C-192 and C-145

The fibrinogen was prepared by sodium sulfate precipitation from human plasma [9]. DesAABB fibrin monomer was prepared in 0.02 M acetic acid was prepared during reaction fibrinogen+thrombin [10]. Polymerization of fibrin desAA and desAABB was studied in the polymerization medium containing at a low concentration thrombin at pH 5.3 [7]. In the experience of the system fibrinogen+thrombin in polymerization medium to add declared calixarene C-192 at a concentration of 0.5 mM. In this case, the maximum rate of fibrin polymerization (Vmax) is greatly reduced, significantly increased the lag-time (τ) and reduced the final turbidity of fibrin clot (Δh) (FIG. 1).

The declared calixarene C-192 and C-145 was added on the desAABB fibrin polymerization medium at a concentration of 0.5 μM. In this case, there is a decreased of maximum rate of fibrin polymerization (Vmax), increased significantly of the lag-time (τ) and decreased the final turbidity of fibrin clot (Δh) too (FIG. 2).

### Example 5

The study of desAABB fibrin polymerization in the thrombin-fibrinogen reaction by transmission electron microscopy in the present and the absent of declared calixarenes C-192 and C-145

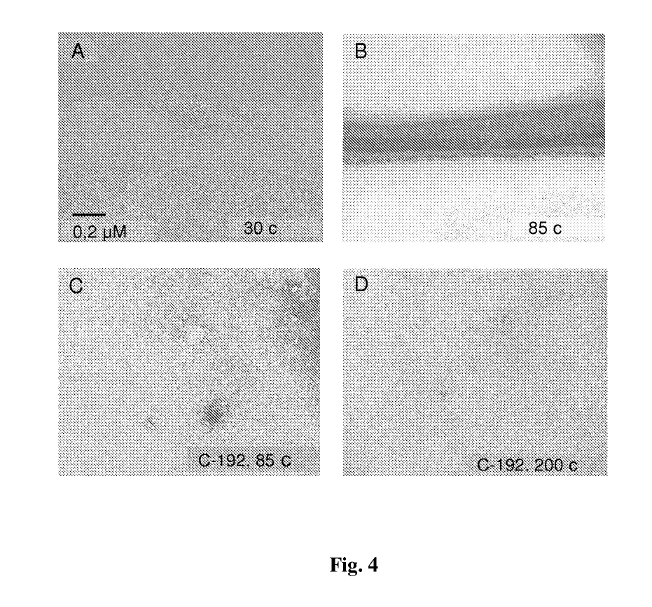

The analysis of the electron micrographs of the fibrin formed in the fibrinogen+thrombin reaction at different time intervals after the polymerization process beginning in the absence of calixarene C-192 (FIG. 4, A and B) and in the presence of calixarene C-192 (FIG. 4, C, D). It was shown that the declared calixarene C-192 inhibits the first stage of fibrin polymerization protofibril building of monomer molecules.

The samples of polymerizing fibrin produced in the thrombin-fibrinogen reaction in the absence or the presence of calixarene C-192 were taken out of the reaction medium at various times, placed on a carbon-coated grid for 2 min and then stained with 1% (w/v) uranyl acetate for 1 min. Transmission electron microscopy was performed with an H-600 electron microscope (Hitachi, Tokyo, Japan). Electron micrographs were obtained at −50 000 magnification.

### Example 6

The measuring of prothrombin time (PT) and activated partial thromboplastin time (APTT) for coagulation of human plasma in the presence of calixarene C-192.

The effects of calixarene C-192 on the coagulation of human blood plasma were studied using a coagulometer (CT 2410 ‘Solar’, Belarus). Reagents were used (<<Renam>>, Russia): control blood plasma with normal hemostasis, “Renamplastin” standardized for international sensitivity index to measuring of the prothrombin time, which shows the activation of the outer pathway of blood clotting; APTT-test—to measuring the activated partial thromboplastin time, which reflects the activation of an internal pathway system blood clotting.

Using coagulometer measured the prothrombin ratio, which is calculated using the formula:

PR=PTₑ/PT_{c}, (1),

where: PR—prothrombin ratio; PTₑ—prothrombin time in the investigating blood plasma;
PT_{c}—prothrombin time in the control blood plasma.

The prothrombin time were calculated using the method [11]. The dissolved calixarene C-192 at concentration of 50 μM was added to cuvette in the experience. The prothrombin ratio calculating by formula (I) equals 1.6.

The activated partial thromboplastin time calculated by the method [11]. In the APTT-test comparing the formation of the fibrin clot in control samples: pure blood plasma specimens and blood plasma, in which the solute of calixarene C-192 at concentration of 50 μM. The prothrombin ratio Calculated by formula (1) equals 5.4.

The data obtained in prothrombin ratio by two different methods (the method of determination of prothrombin time—1.6 and APTT-tests—5.4) suggest that the inhibition of fibrin polymerization by calixarene C-192 takes place in the presence of all the components of blood plasma. This fact makes it possible to consider the calixarene C-192 as a substance to design of a antithrombotic drug.

Thus, two independent methods show that the declared calixarene C-192 and its sodium salt (calixarene C-145) are highly specific inhibitors of fibrin polymerization and blood clotting.

The fibrin polymerization leads to the formation of three-dimensional network of fibrin, which is the frameworc of a blood thrombus. Therefore declared calixarenes have an appointment as substances to design high efficient antithrombotic drugs.

### REFERENCES

1. U.S. Pat. No. 4,455,290 US. Jun. 19, 1984.
2. Pandya B. V., Gabriel J. L., O'Brien J., Budzynski A. Z. Polymerization site in the beta chain of fibrin: mapping of the B beta 1-55 sequence//Biochemistry.-1991.-30, 1.-P. 162-168.
3. Laudano, A. P. Doolittle R. F. Synthetic peptide derivatives that bind to fibrinogen and prevent the polymerization of fibrin monomers.//Proc. Natl. Acad. Sci. USA.-1978.-V. 75.-P. 3085-3089.
4. Patent application. 94032284/04 RU, Jul. 9, 1994.
5. Vovk A. I., Kalchenko V. I., Cherenok S. A., Kukhar V. P., Muzychka O. V., Lozynsky M. O. Calix[4]arene methylenebisphosphonic acids as calf intestine alkaline phosphatase inhibitors//Org. Biomol. Chem.-2004.-Vol. 2.-P. 3162-3166.
6. P. G. Gritsenko, E. V. Lugovskoy, T. A. Koshel, S. O. Cherenok, V. I. Yuschenko, Chemishov, O. A., V. I. Kalchenko, S. V. Komisarenko. The effect of calixarene-methylenbisphosphonic acids on fibrin polymerization.//Dop. NAS Ukr., 2010. N 1. P. 175-179.
7. Lugovskoi E. V., Makogonenko E. M., Chudnovets V. S., Derzskaya S. G., Gogolinsikaja G. K., Kolesnikova I. N., Bukhanevich A. M., Komisarenko S. V. The study of fibrin polymerization with monoclonal antibodies//Biomedical Science-1991.-N. 2.-P. 249-296.
8. M. L. Belenky. The elements of quantifying the effect of pharmaceutics. The government publication of the medical literature. Leningrad.-1963.-148 p.
9. Varetskaya T. V. Microheterogeneity of fibrinogen. Cryofibrinogen//Ukr Biokhim Zh.-1960.-32.-P. 13-24.
10. Belitser V. A., Varetskaja T. V., Malneva G. V. Fibrinogen-fibrin interaction//Biochim. Biophys. Acta.-1968.-154.-P. 376-380.
11. S. Barkagan, A. P. Momot. Diagnosis and controlled treatment of hemostatic disorders//M.: Nyudiamed.-2001.-292 p.

1. 5,11,17,23-tetrakis[bis(dihydroxyphosphoryl)methyl]calix[4]arene: 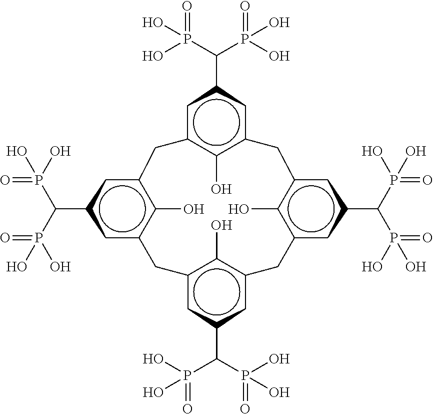
and sodium salt thereof: 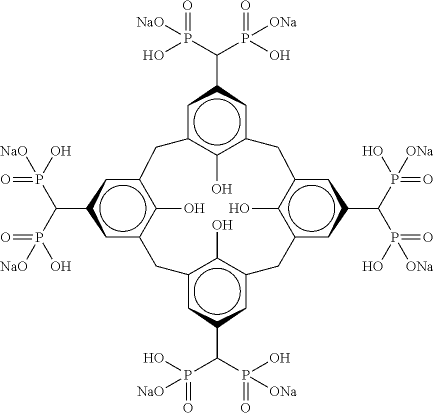
as inhibitors of fibrin polymerization.

2. The compound according to claim 1 wherein the compound is represented by specific inhibitors of fibrin monomer polymerization and blood plasma coagulation of human.

3. The compound according to claim 1 or to claim 2 wherein the compound has a first appointment as a substance for antithrombotic drugs.
